(19) United States
(12) Patent Application Publication
(10) Pub. No.: US 2009/0222319 A1
(43) Pub. Date: Sep. 3, 2009

(54) SYSTEM AND METHOD FOR CALCULATING PIECEWISE PRICE AND INCENTIVE

(75) Inventors: Rong Zeng Cao, Beijing (CN); Wei Ding, Beijing (CN); Shun Jiang, Beijing (CN); Juhnyoung Lee, Yorktown Heights, NY (US); Gregory C. Morris, Beacon Hill (AU); Chunhua Tian, Beijing (CN)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/040,472

(22) Filed: Feb. 29, 2008

(51) Int. Cl. G06Q 10/00; G06Q 30/00

(52) U.S. Cl. 705/10; 705/400

(57) ABSTRACT

System and method for determining piecewise pricing, in one aspect, generate a distribution function of transactions based on a plurality of data records associated with said transactions. One or more correlations between total cost and one or more performance measures are analyzed. Demand model is generated based on the distribution function. Piecewise pricing or level-price pairs are determined for a plurality of levels of performance measure, based on said one or more correlations between total cost and one or more performance measures, said demand model, and desired profit margin.

### CROSS-REFERENCE TO RELATED APPLICATIONS

This application is related to the following commonly-owned, co-pending United States patent applications filed on even date herewith, the entire contents and disclosure of each of which is expressly incorporated by reference herein as if fully set forth herein. U.S. patent application Ser. No. (YOR920070662US1 (21890)), for “SYSTEM AND METHOD FOR COMPOSITE PRICING OF SERVICES TO PROVIDE OPTIMAL BILL SCHEDULE”; U.S. patent application Ser. No. (YOR920070663US1 (21877)), for “SYSTEM AND METHOD FOR GENERATING OPTIMAL BILL/PAYMENT SCHEDULE”; U.S. patent application Ser. No. YOR920070664US1 (21876)), for “SYSTEM AND METHOD FOR CALCULATING POTENTIAL MAXIMAL PRICE AND SHARE RATE”.

### FIELD OF THE INVENTION

The present application generally relates to pricing of services, and more particularly to determining piecewise price and incentive.

### BACKGROUND OF THE INVENTION

Buyers and suppliers of information technology (IT) services today work with a variety of different pricing schemes to meet their individual project and business needs. Historically, the great majority of service contracts were billed on a time and materials basis. However, a recent market and business survey revealed that users and vendors are increasingly moving toward more flexible contract structures built around a combination of fixed-fee/fixed-bid service components and value-based/risk-reward mechanisms based on usage or defined service-level objectives.

Common approaches to pricing include cost-oriented pricing, competitive-oriented pricing, and value-based pricing approaches. In cost-oriented pricing, the seller determines the cost involved in providing a specific service and adds the desired profit margin to calculate price. The cost is set based on the internal cost to deliver the service and/or product plus a target margin on the cost. In competitive-oriented pricing, price is determined with reference to the prices of the competitors.

Value based pricing usually refers to the setting of price as a function of the expected value to be derived from the services and/or products. A set of value drivers in value-based pricing may vary from industry to industry. In a value based approach the price is based on the total value delivered to the client. Internal costs and target margins are only considered to ensure that the value-based price meets or exceeds the planned target margin. Value based pricing can provide greater negotiating leverage and ability to win the contract for services and/or products, and typically results in the higher profit margins. Thus, more and more projects are using value-based pricing model.

Different value-based pricing models focus on different aspects for providing value-based pricing. For instance, part fixed/part risk-reward pricing model is a form of value-based pricing models that links the price to clearly defined business value improvements, for example, economic value to the customer for the goods/services that is provided. This economic value can be measured in additional revenue, cost savings, improved cash flow, inventory turns, etc. The following formulas illustrate some examples of determining value-based price using economic values:
Base Fee+gain sharing on cost savings (e.g., −10% cost savings every year for 3 years);
Base Fee+gain sharing on completion date (e.g., +/−10% depending on defined implementation date);
Base Fee+gain sharing on added value (e.g., link price to efficiency business process improvement);
Base Fee+gain sharing on company level metrics (e.g., link price to corporate level metrics such as ROCE (Return on Capital Employed), ROA (Return on Assets); share price improvement of the client; KPIs (Key Performance Indicators) specified in balanced scorecard, meeting schedule, budget, and/or quality in project delivery; building capability in process and/or technology platform; client satisfaction).

Another example of value-based pricing model is self-funding pricing model. This model considers risks based on phased funding upon attainment of benefits. For example, first phase of work is funded based on the successful attainment of benefit for the next phases of work. Solution financing model provides yet another variation of value-based pricing model that includes complete or partial financing of an appropriate solution. Completely variable pricing is another value-based pricing model and links the price to clearly defined business value improvements and covers the entire project fee plus potential gain sharing based on some metrics. Utility/on-demand pricing is yet another example of value-based pricing model, in the form of “usage-based” feed, that is, price depending on usage of services, outsourced process performance, IT infrastructure usage.

While many IT services firms utilize the value-based pricing models, others have varied pricing determination depending on the state of client's business goals and individual projects. For instance, if client's underlying business goals and maturity of its internal processes are small and have poorly scoped engagements, time and materials pricing is seen as the appropriate pricing model. On the other hand, if the client has well defined projects drawn from previous project experience, fixed-fee pricing is viewed as more appropriate. Among trusted partners, where the responsibilities of each player are clear and agreeable, value-based pricing is preferred since outstanding results can be delivered if done properly.

In practicality, deals may incorporate a variety of components and situations resulting in a hybrid deal structure. Thus, it is desirable to have an automated system and method that can take into account the various and hybrid characteristics of a project or business goal and provide an optimal pricing model, for example, that is based on different pricing models for different sets of characteristics found in the overall project or business goal.

Profitability can be extremely sensitive to changes in price. For instance, studies show that given a cost structure typical of large corporations, a 1% boost in price realization yields a net income gain of 12%. A pricing model that considers hybrid characteristics of a project and uses different pricing schemes and further optimizes the ratio of the usage of those different pricing schemes in the pricing model would provide better and more accurate pricing and result in much improved profit.

### BRIEF SUMMARY OF THE INVENTION

A method and system for determining piecewise price and/or incentive are provided. The method, in one aspect, may comprise generating a distribution function of transactions based on a plurality of data records associated with said transactions, the distribution function being over one or more dimensions. The method may also comprise analyzing one or more correlations between total cost and one or more performance measures using the distribution function and generating a demand model based on the distribution function. The method may further comprise determining a desired profit margin, and determining level-price pairs for a plurality levels of performance measure based on said one or more correlations between total cost and one or more performance measures, said demand model, and said desired profit margin.

A system for determining piecewise price and/or incentive, in one aspect, may comprise a transaction function generator module operable to run on a processor, the transaction function generator module generating a distribution function of transactions based on a plurality of data records associated with said transactions. The distribution function may be defined over one or more dimensions. The transaction function generator module generates a demand model based on the distribution function. A cost analyzer module is operable to run on a processor and map cost to volume of transactions based on the distribution function to determine cost mapping. A pricing threshold calculator module is operable to run on a processor and to receive target profit margin, said cost mapping and said demand model and determine piecewise pricing.

A program storage device readable by a machine, tangibly embodying a program of instructions executable by the machine to perform a method of determining piecewise price and/or incentive may be also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram showing functional components of a system for determining piecewise pricing and/or incentive in one embodiment of the present disclosure.

FIG. 2 is a flow diagram illustrating a method for determining piecewise pricing in one embodiment of the present disclosure.

FIG. 3 shows functional components of a system for determining piecewise pricing and/or incentive in more detail in one embodiment of the present disclosure.

FIG. 4 illustrates piecewise pricing scheme in one embodiment of the present disclosure.

FIG. 5 shows an example of transaction distribution and level-price pairs to mitigate valley and peak effect of transaction.

FIG. 6A and FIG. 6B illustrate two examples of piecewise price.

FIG. 7A and FIG. 7B illustrate two examples of piecewise incentive.

### DETAILED DESCRIPTION

A system and method of the present disclosure in one embodiment provide a pricing model to determine piecewise price and incentive. A piecewise price in one embodiment refers to a piecewise-defined function f(x) of a variable x. An example of a variable x may be performance measure such as usage. In one embodiment, piecewise price definition is given differently on disjoint subsets of its domain. That is, piecewise price may be different for different situation or scenarios. For example, when volume of transaction is over 100, the price is 1 USD/per transaction, otherwise the price is 1.5 UDS/per transaction. An incentive in one embodiment refers to a kind of piecewise pricing used for price differentiation based on a reference value of variable x. For example, +/−10% depending on defined implementation date.

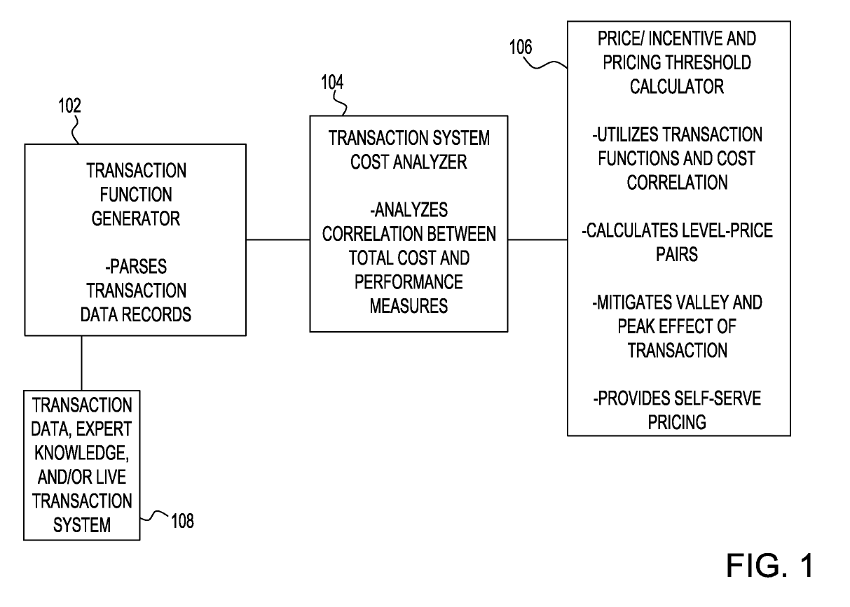

FIG. 1 is a diagram showing functional components of a system for determining piecewise pricing and/or incentive in one embodiment of the present disclosure. Transaction distribution function generator 102 may be logically connected to one or more live transaction system, one or more database systems storing historical data of transaction systems, and/or expert knowledge that is stored or obtained dynamically. The transaction distribution function generator 102 parses a plurality of transaction data records and generates a distribution function of transactions over one or more dimensions such as time and geography. Generally, distribution function (also referred to as cumulative density function (CDF) or probability distribution function) describes the probability that a variable such as the number of transaction, takes on a value less than or equal to number x. Distribution function of number of transactions can be generated by statistical methods, such as curve fitting and Chi-square test. The curve fitting can find a suitable function, for example, normal distribution function, exponential distribution function or power distribution function, etc. to describe the distribution of number of transactions.

Transaction system cost analyzer 104 analyzes the correlation between total cost of project, for example, including software, hardware and service fees, and performance measures such as the number of transactions or other performance guarantees such as project duration and service line agreement (SLA). Price/incentive and pricing threshold calculator 106 utilizes the transaction distribution functions from the generator 102 and one or more statistical techniques, and also the cost correlation information from the cost analyzer 104, calculates level-price pairs for various levels of performance measure as to maximize the service provider profitability and reduce cost.

Price/incentive and pricing threshold calculator 106 may also mitigate the valley and peak effect of transaction to reduce the system cost. The valley and peak of transaction influences the cost of service provider. Users can define the relationship between number of transactions and operation cost. Based on the relationship defined by users, the level-price pairs can be generated. Since the level price pairs are not linear, the differentiation among the level price pairs will force the users to reduce the transaction at peak time and increase the transaction at non-peak time.

Price/incentive and pricing threshold calculator 106 further may provide a user self-serve pricing for individual's transaction and/or performance levels or price and/or incentive. The effect of level based pricing is to clip peak demand and improve the capacity utilization, that is to induce some consumption to shift, away from the times of peak demand, and toward times of lower demand. Consumers are rewarded—in the sense that they pay less—for using the service when there is ample unutilized capacity, rather than when demand takes up or even exceeds all the capacity. This makes for more efficient use of existing capacity. The functional components shown FIG. 1 may be implemented as one or more modules that can execute on a computer processor.

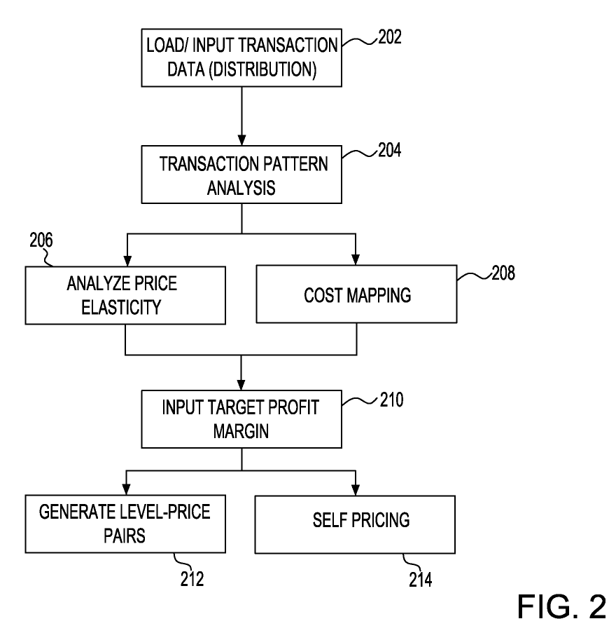

FIG. 2 is a flow diagram illustrating a method for determining piecewise pricing in one embodiment of the present disclosure. At 202 transaction data is loaded, or otherwise input and made available for access. For instance, the transaction data may be loaded or received from live transaction system or from database repository storing historical data. At 204, the transaction data is analyzed. The data analyzed may include the number of transactions, price during those transactions, etc. The transaction pattern is determined and distribution function of the transactions is generated.

At 206, price elasticity is analyzed. For instance, when the price of a service or good or like falls, the quantity consumer demand (i.e., usage) of the service typically rises; if it costs less, consumers buy more. Price elasticity measures the responsiveness of a change in quantity demanded for a service to a change in price. In another word, it is a quantitative measure of consumer behavior that indicates the quantity of usage of a service depending on its increase or decrease in price. Price elasticity can be calculated by the percent change in the usage by the percent change in price. An example of a formula that may be used to calculate the coefficient of price elasticity is provided below.
An example formula used to calculate the coefficient of price elasticity of demand for a given product:

Point Elasticity=(% change in Usage)/(% change in Price)=(DU/U)/(DP/P).

For example, suppose the price elasticity equals 4. This elasticity indicates that if the price increases by 1%, the quantity demanded falls by 4%. The quantity demanded and price move in opposite directions. Thus, if a price elasticity of demand is known, given a price change, the percentage change in the quantity demanded can be computed. For example, if price increased by 2% and the price elasticity of demand equals 3, then quantity would decline by 6%. Similarly, given a percentage change in the quantity demanded and the price elasticity of demand, the percentage change in price can be computed that brought about the percentage change in the quantity demanded. Generally, analyzing price elasticity allows to forecast demand at different or alternative prices, given the price elasticity, and a forecast of demand at a particular price.

At 208, cost mapping is performed using the transactions, for example, usage, analysis. For example, the cost of service provider is mapped to the selected variable, e.g. usage. Given the usage, a model in one embodiment of the present disclosure can calculate the cost of service provider.

At 210, target profit margin is input and received. Target profit margin, for instance, may be based on the profit margin desired or determined by a provider. At 212, piecewise price also referred to as level-price pair is generated based on price elasticity, cost mapping, and target profit margin. For instance, at 206, forecasted usage at different prices were determined; at 208, provider's cost for different usage volume was determined; and at 210, desired profit margin was determined. Given the desired profit margin, it is possible to determine the optimum piecewise price, for instance by solving an optimization problem.

At 214, self-pricing is determined. In self-pricing, a service consumer can determine the price at some degree, i.e., “pay what you can policy”. A self-pricing function in one embodiment offers consumer self-design and self-pricing flexibility, and also considers consumer's interest and preference. Consumers decide what may be the right pricing in order to receive the best deal they can. For example, given the usage forecast, the cost of provider and provider's desired profit margin, the consumer may choose usage intervals. The system and method of the present disclosure can calculate one or more prices for each interval. Similarly, the consumer may input several prices, and the system and method of the present disclosure can propose the usage range at each price. Self-pricing functionality of the present disclosure considers consumer's interest while also considering the providers gain.

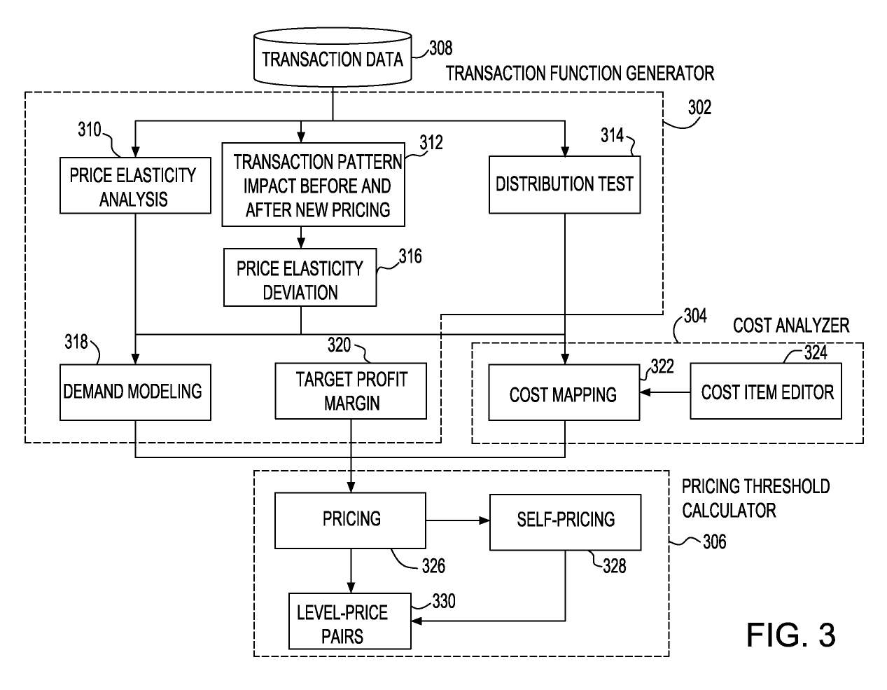

FIG. 3 describes the detailed functional components of a system for determining piecewise pricing and/or incentive in one embodiment of the present disclosure. Transaction function generator 302 receives transaction data 308 and generates distribution of transactions. Transaction data 308 may be database or like that stores transaction data, price elasticity and demand model, pricing information. Transaction data 308 may also be live or dynamic data received from one or more live transaction systems. In one embodiment, transaction function generator 302 may include functionalities or modules such as price elasticity analysis 310, transaction pattern impact analysis 312, distribution test 314, price elasticity deviation 316, demand modeling 318, and target profit margin 320. Price elasticity analysis functionality or module 310 calculates the price elasticity based on the transaction data and prices from transaction data 308. In one embodiment, price elasticity analysis, for example, may be performed, the first time piecewise pricing is determined, then thereafter may be stored in transaction data 308 and used for subsequent piecewise pricing iterations. If the price elasticity analysis has been performed before, a functionality, component or module of transaction function generator at 312 analyzes the transaction pattern impact before and after new pricing. Transaction analyzer or transaction pattern impact analysis functionality or module 312 and price elasticity deviation functionality or module 316 may perform verifications. If the price elasticity analysis has been performed before and the new pricing has been updated, the latest or new transaction data is collected at transaction data 308. Transaction analyzer or transaction pattern impact analysis functionality or module 312 analyzes this updated transaction data and determines whether the transaction data still follows or is consistent with the known price elasticity. If the latest transaction data does not follow the known price elasticity, price elasticity deviation functionality or module 316 calculates the price elasticity deviation due to the change of pricing. If the deviation is above a pre-defined threshold, the system of the present disclosure may suggest revised price elasticity, and trigger demand modeling functionality 318 to generate a new demand model based on the revised price elasticity, and also trigger pricing threshold calculator 306 to generate a new pricing model.

These two transaction patterns are used for price elasticity deviation analysis functionality or module 316, which determines whether to revise the price elasticity model. Generally, there are many types of distributions, for example, normal distribution, power distribution, etc. Distribution test functionality or module 314 leverages the transaction data from 308 to test and select the distribution function. Price elasticity from 310 or 316, and a distribution function from 314 are used for demand modeling 318, which formulates the function relationship of demand and price. The desired profit margin may be input, pre-defined, or obtained from composite pricing model disclose in a related application.

Cost analyzer module or functionality 304 may include cost mapping 322 and cost item editor 324 functionalities or modules. Given the distribution function of transaction, a cost mapping functionality or module 322 maps the cost of provider to volume of transaction. There may be several mapping functions, such as linear function, piecewise linear function, and nonlinear function, etc. Cost item editor 324 edits the types of cost of provider, which may be input to cost mapping functionality or module 322 for cost mapping.

Pricing threshold calculator functionality or module 306 may include pricing functionality or module 326, self-pricing functionality or module 328, which may determine level-price pair 330. Based on a demand model from demand modeling functionality or module 318, target profit margin from target profit margin functionality or module 320 and cost mapping information from cost mapping functionality or module 322, the pricing component 326 can generate the piecewise price or incentives 330 to one or more consumers, for example, service consumer. The same information can also be input to self-pricing functionality or module 328, which enable consumer (e.g., service consumer) to select the preferred transaction intervals or piecewise price. Self-pricing generates the proposed piecewise price based on service consumer's input while ensuring provider's desired profit margin.

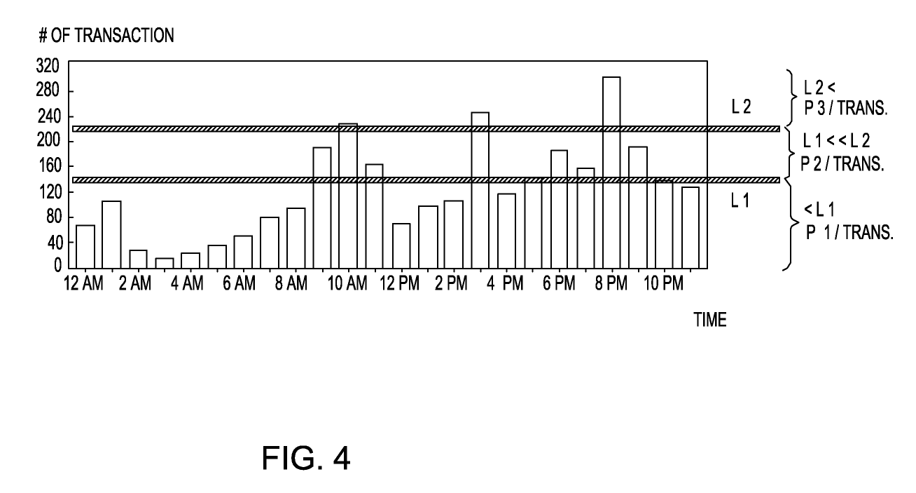

FIG. 4 illustrates an example of piecewise pricing. This diagram is an example of number of transactions over time. Given the transaction data and target revenue and/or profit, the piecewise pricing can determine price and/or fee P₁, P₂, P₃, . . . Pₙ when number of transaction level L₁, L₂, . . . Lₙ₋₁ are known. Meanwhile, given price and/or fee P₁, P₂, P₃, . . . Pₙ the piecewise pricing can determine number of transaction level L₁, L₂, . . . Lₙ₋₁.

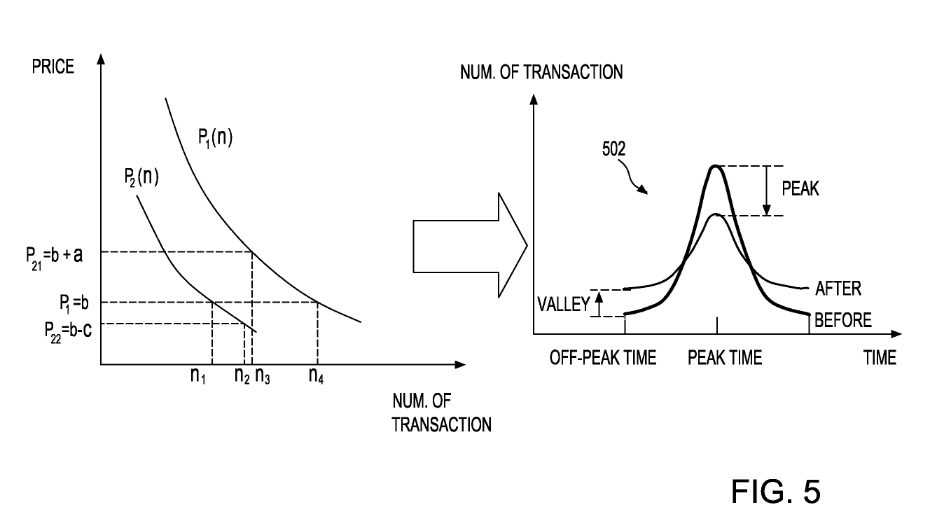

FIG. 5 illustrates how the piecewise pricing (level-price pairs) can clip peak demand and improve the capacity utilization. In FIG. 5, P₁(n) and P₂(n) are the service consumer's willingness to pay during peak and off-peak conditions. With uniform price b, during off-peak conditions demand could be n₁, and during peak conditions demand could be n₄. Sometimes n₄ may exceed capacity. Assuming that this demand exceeds capacity, the provider may need to add additional capacity cost. Through the additional charge a, the price of peak condition will be a+b, and according to P₁(n), demand is constrained to n₃. The service provider would recover its costs exactly. Similarly, the demand will be n₂ in off-peak condition with price of b−c, if for example, the capacity cost is reduced by c and given P₁(n). The graph shown at 502 illustrates the effect of piecewise pricing, which more evenly distributes number of transactions over time as a result of the generated pricing.

The piecewise pricing scheme illustrated in this disclosure is an example of price optimization that may be used in composite pricing model disclosed in the related application. As disclosed therein, a composite pricing model may comprise several pricing models, e.g., elementary pricing models. The piecewise pricing scheme of the present disclosure may be one of the pricing models used in a composite pricing model. Piecewise pricing may be used for utility pricing model and performance adjusted pricing model. For example, in case of utility pricing, the piecewise pricing model of the present disclosure may calculate the “fee/transaction” in case of milestone based pricing, the piecewise pricing model of the present disclosure may calculate incentive per schedule attainment. In one embodiment, one or more components described in the related application for generating and analyzing optimal composite pricing model may be connected to or communicate with one or more components of the present disclosure for piecewise pricing. For instance, the piecewise pricing model of the present disclosure may provide optimized piecewise pricing scheme or calculation methodology to the composite pricing model. The piecewise pricing model of the present disclosure may be also linked to analysis components described with reference to the composite pricing model in the related applications to aid in performing various analyses such as sensitivity analysis associated with piecewise pricing or self-pricing.

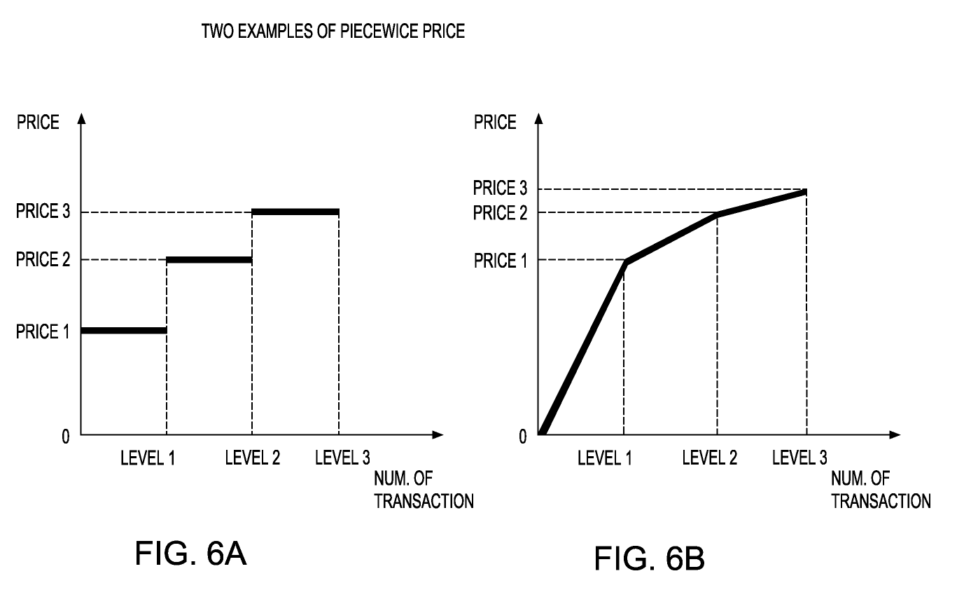

FIG. 6A and FIG. 6B illustrate two examples of piecewise price. FIG. 6A is an example of a step function that illustrates piecewise price. At transaction Level 1 (e.g., transactions such as demand or usage), Price 1 is given. At transaction Level 2, price of Price2 is determined given. At transaction level 3, price is at Price 3. Similarly, FIG. 6B shows n example of a non-linear piecewise price function.

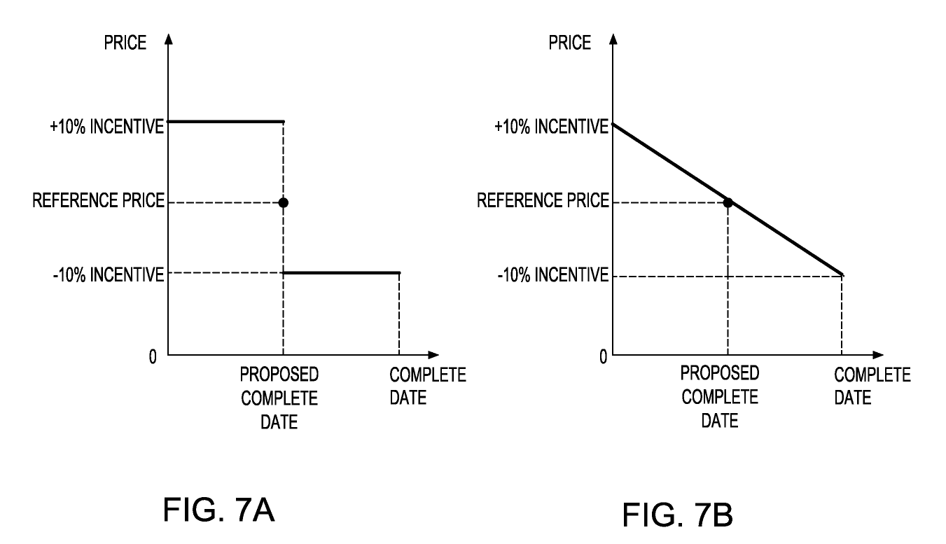

FIG. 7A and FIG. 7B illustrate two examples of piecewise incentive. FIG. 7A shows a step function and FIG. 7B shows linear function. Differences in price show differences for completion date. For instance, given a price incentive (e.g., less 10% of reference price), consumers may be willing to accept later completion date of service, delivery of goods, etc.

The method of the present disclosure in one embodiment may be embodied as a program, software, or computer instructions embodied in a computer or machine usable or readable medium, which causes the computer or machine to perform the steps of the method when executed on the computer, processor, and/or machine.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware) electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A computer-implemented method for determining piecewise price and/or incentive, comprising:
generating a distribution function of transactions based on a plurality of data records associated with said transactions, the distribution function being over one or more dimensions;
analyzing one or more correlations between total cost and one or more performance measures using the distribution function;
generating a demand model based on the distribution function;
determining a desired profit margin; and
determining level-price pairs for a plurality levels of performance measure based on said one or more correlations between total cost and one or more performance measures, said demand model, and said desired profit margin.

2. The method of claim 1, wherein the step of generating a demand model includes determining price elasticity.

3. The method of claim 1, wherein the step of determining a desired profit margin include receiving input data from a user, receiving automatically generated data, or receiving stored data, or combinations thereof.

4. The method of claim 1, wherein the step of determining level-price pairs includes using a programming model with input data comprising said one or more correlations between total cost and one or more performance measures, said demand model, and said desired profit margin.

5. The method of claim 1, wherein the step of determining level-price pairs includes generating a programming model.

6. The method of claim 1, comprising:
establishing self-pricing.

7. The method of claim 6, wherein the step of establishing self-pricing includes:
establishing one or more self-pricing for one or more transaction levels.

8. The method of claim 6, wherein the step of establishing self-pricing includes:
establishing one or more transaction levels for one or more desired prices.

9. The method of claim 1, wherein said one or more dimensions include time or geography or combination thereof.

10. The method of claim 1, further including:
receiving the plurality of data records; and
parsing said plurality of data records for generating the distribution function of transactions.

11. The method of claim 10, wherein the plurality of data records are received from one or more live transaction system, one or more database systems storing historical data of transaction system, or one or more experts having knowledge of said data records, or combinations thereof.

12. The method of claim 1, wherein said one or more performance measures include number of transactions, project duration, or service line agreement, or combinations thereof.

13. The method of claim 1, wherein the total cost includes total cost of hardware, software, and services.

14. The method of claim 1, wherein said level-price pairs are associated with services, or goods, or combination thereof.

15. A system for determining piecewise price and/or incentive, comprising:
a transaction function generator module operable to run on a processor, the transaction function generator module generating a distribution function of transactions based on a plurality of data records associated with said transactions, the distribution function being over one or more dimensions, the transaction function generator module further operable to generate a demand model based on the distribution function;
a cost analyzer module operable to map cost to volume of transactions based on the distribution function to determine cost mapping; and
a pricing threshold calculator module operable to receive target profit margin, said cost mapping and said demand model and determine piecewise pricing.

16. The system of claim 15, wherein the transaction function generator module is farther operable to determine price elasticity based on the distribution function, said price elasticity being used to generate the demand model.

17. The system of claim 16, wherein the transaction function generator module further includes a price elasticity deviation module operable to update said price elasticity based on the distribution function of transactions.

18. The system of claim 16, wherein the pricing threshold calculator module further includes a self-pricing module operable to establish one or more self-pricing for one or more transaction levels, or one or more transaction levels for one or more desired prices, or combinations thereof.

19. The system of claim 16, further including transaction database storing live transaction data, historical data of transactions, expert knowledge of transaction data, or combinations thereof.

20. A program storage device readable by a machine, tangibly embodying a program of instructions executable by the machine to perform a method of determining piecewise price and/or incentive, comprising:
generating a distribution function of transactions based on a plurality of data records associated with said transactions, the distribution function being over one or more dimensions;
analyzing one or more correlations between total cost and one or more performance measures using the distribution function;
generating a demand model based on the distribution function;
determining a desired profit margin; and
determining level-price pairs for a plurality levels of performance measure based on said one or more correlations between total cost and one or more performance measures, said demand model, and said desired profit margin.

21. The program storage device of claim 20, wherein the step of generating a demand model includes determining price elasticity.

22. The program storage device of claim 20, wherein the step of determining a desired profit margin include receiving input data from a user, receiving automatically generated data, or receiving stored data, or combinations thereof.

23. The program storage device of claim 20, wherein the step of determining level-price pairs includes using a programming model with input data comprising said one or more correlations between total cost and one or more performance measures, said demand model, and said desired profit margin.

24. The program storage device of claim 20, wherein the step of determining level-price pairs includes generating a programming model.

25. The program storage device of claim 20, wherein the step of establishing self-pricing includes:
establishing one or more self-pricing for one or more transaction levels, or one or more transaction levels for one or more desired prices, or combinations thereof.
